(19) United States
(12) Patent Application Publication
(10) Pub. No.: US 2024/0117892 A1
(43) Pub. Date: Apr. 11, 2024

(54) SANITARY VALVE

(71) Applicant: Neoperl GmbH, Müllheim (DE)

(72) Inventors: Jacek KOWOL, Gundelfingen (DE); Marc TEMPEL, Freiburg (DE); Yichao BIAN, Müllheim (DE)

(73) Assignee: Neoperl GmbH, Müllheim (DE)

(21) Appl. No.: 18/276,903

(22) PCT Filed: Feb. 18, 2022
(86) PCT No.: PCT/EP2022/054040

§ 371 Date: Aug. 11, 2023

(30) Foreign Application Priority Data
Feb. 19, 2021 (DE) 20 2021 100 839.3

(51) Int. Cl. F16K 31/385; F16K 11/074; F16K 27/04

(52) U.S. Cl. CPC F16K 31/3855; F16K 11/0743; F16K 27/045

(57) ABSTRACT

A sanitary valve having a main valve and a pilot valve by which the main valve is actuatable between open and closed positions. A valve diaphragm movable by a valve tappet connected to a push-push mechanism provides for switching between switching positions corresponding to open and closed positions. The main and pilot valves are in an inner housing that is rotatably mounted in an outer housing. The outer and inner housings have paired valve openings, with a first valve opening pair arranged coaxially to a rotational axis designed as a valve outlet and a second valve opening pair provided as a valve inlet. The second pair is movable into congruence according to the rotational position between the outer and inner housings so the clear opening cross-section, kept free, of the at least one valve inlet produced by the congruence of the second valve openings is modified.

### CROSS-REFERENCE TO RELATED APPLICATIONS

This application is a 371 National Phase of PCT/EP2022/054040, filed Feb. 18, 2022, which claims priority to German Patent Application 20 2021 100 839.3, filed Feb. 19, 2021, both of which are incorporated herein by reference as if fully set forth.

### TECHNICAL FIELD

The invention relates to a sanitary valve comprising a main valve, which has a movable diaphragm, and comprising a pilot valve, by means of which the main valve can be actuated between an open position and a closing position, wherein the position of the diaphragm can be specified by the position of a valve tappet that is connected to a push-push mechanism, by means of which the valve tappet can be switched between a switching position corresponding to the open position and a switching position corresponding to the closing position.

### BACKGROUND

A sanitary valve of the type mentioned at the outset is already known from DE 10 2017 105 200.3 and can be interposed in the water path of a water supply line for switching in or out. For this purpose, the previously known sanitary valve has a main valve, the valve inlet of which is connected to an inflow-side line portion and the valve outlet of which is connected to an outflow-side portion of the water path. The main valve has a movable diaphragm which, in the closing position of the main valve, rests tightly against a valve seat, and which, in an open position, clears the valve seat. The aforementioned sanitary valve also has a pilot valve, by means of which the main valve can be actuated between an open position and a closing position. In this case, the position of the diaphragm can be specified by the position of a valve tappet, which is in control connection with a push-push mechanism, by means of which the valve tappet can be switched between a switching position corresponding to the open position and a switching position corresponding to the closing position. Between the open position and the closing position, the push-push mechanism can also specify, in stages, intermediate positions, in which the diaphragm is held at different distances from the valve seat and thus releases a reduced flow cross-section compared with the open position. Continuous volume regulation of the water volume flowing through the main valve, however, is not possible with the previously known sanitary valve.

A sanitary valve is already known from EP 3 561 351 A1, which can be integrated as a mixing and shut-off device in a sanitary outlet fitting.

The sanitary valve already known from EP 3 561 351 A1 has a valve housing, a valve unit with shut-off control for controlling a fluid flow volume and mixing control for controlling a fluid mixing ratio, a shut-off control device, a mixing control device which can be rotated about a mixing rotational axis between a first mixing end position and a second mixing end position, a self-resetting device which provides a resetting force for automatic resetting of the mixing control device to the first mixing end position, and a latching device which couples the mixing control device to the valve housing body latchingly, wherein a latching force is greater than the resetting force in the open position of the shut-off control device and less than the resetting force in the shut-off position. A cartridge unit is provided in the valve housing of the sanitary valve already known from EP 3 561 351 A1, which has a control disc and a distributor disc cooperating therewith, which are made of ceramic. By actuating a push button, the valve unit can be moved between an open position and a closing position. To activate the mixing control of the valve unit used in the known sanitary valve, the mixing control device can be rotated between the first mixing end position and the second mixing end position of the valve unit. As the mixing control device is rotated from the first mixing end position toward the second mixing end position, a helical spring element of the self-restoring device acting as a tension spring is progressively pulled in length, causing the helical element to exert a corresponding elastic restoring force on the mixing control device toward the first mixing end position. The first mixing end position can correspond, for example, to a cold water position and the second mixing end position to a warm or hot water position, in which only cold water or, respectively, only warm/hot water then exits from the water outlet of the known sanitary valve. In the intermediate positions, mixed water consisting of cold water and warm/hot water is provided at the water outlet.

Due to the multi-part design of the sanitary valve known from EP 3 561 351 A1 and the cartridge unit having a pair of ceramic discs, the production of the known sanitary valve is associated with a not inconsiderable effort.

A sanitary valve is already known from DE 10 2016 115 793 A1, which is installed in a main faucet body of a sanitary outlet fitting. The sanitary valve known from DE 10 2016 115 793 A1 has a water inlet part, a mixing chamber and a water outlet part, wherein cold water and hot water flow into the water inlet part and are mixed in the mixing chamber in a specified ratio to form mixed water, and wherein the mixed water exits via the water outlet part. A water saving valve is fixed between the mixing chamber and the water outlet part of the known sanitary valve, wherein a valve stem is arranged on the water saving valve. By touching and moving the valve stem, the water saving valve is opened to allow the mixed water to flow out of the mixing chamber of the water saving valve and to flow further to the water outlet. The valve stem of the water-saving valve is connected to a touch element that is at least partially exposed outside the main body of the faucet, so that the user can operate the touch element to touch and move the valve stem of the water saving valve. Here, the touch element also has an actuating part that is inserted into the water outlet part of the aforementioned sanitary valve. When the touch element is pressed, it can be displaced in the longitudinal direction of the water outlet part so that the actuating part contacts the valve stem of the water-saving valve, thereby displacing it. The touch-operable sanitary valve further comprises a resetting device by which the touch member then automatically resets when the pressure applied to the touch member is released.

A device for regulating the water in a shower, a bathroom or a sink is known from EP 2 865 929 A1. The device comprises a shutter with at least one metal part that is slidable inside a cylindrical chamber with a diameter substantially equal to the diameter of the shutter, a magnet connected to the metal part of the shutter, and a push button that can be actuated to move the magnet and the shutter along an axis of the cylindrical chamber to two different positions corresponding to an opening of the water flow or a closing of the water flow. The push button is also rotatable about the axis to vary the open position of the closure along the axis and a corresponding flow rate. The device also has an axis rotatable knob to change a temperature of the water.

Also known from DE 20 2017 106212 U1 is a valve, in particular a temperature-controllable press-type valve.

### SUMMARY

The object is to create a compact sanitary valve of the type mentioned at the outset, which can be produced with little effort, which can be opened and closed by a simple pressure or tactile movement, and which allows a gradual volume regulation of the fluid flowing through or a continuous mixing of the fluids flowing in from different fluid inlets.

This object is achieved according to the invention in the case of the sanitary valve of the type mentioned at the outset in particular in that the main valve and the pilot valve are provided in the interior of an inner housing, which inner housing is rotatably mounted in an outer housing about a rotational axis, and in that the outer housing and the inner housing have paired valve openings, of which a first pair of valve openings arranged coaxially to the rotational axis is designed as a valve outlet and at least one second pair of valve openings lying outwardly relative to the rotational axis is provided as at least one valve inlet, which at least one second pair of valve openings is capable of being brought into congruence according to the rotational position between the outer and inner housings such that the clear opening cross-section, kept free, of the at least one valve inlet produced by the congruence of said at least one second pair of valve openings can be modified.

The sanitary valve according to the invention has a main valve, which has a movable diaphragm as a valve body. The sanitary valve according to the invention also has a pilot valve, by means of which the main valve can be controlled between an open position and a closing position. In this case, the position of the diaphragm can be predetermined by the position of a valve tappet, which is connected to a push-push mechanism. Such push-push mechanisms are already known as rotary/latching or ballpoint-pen mechanisms and allow the valve tappet to be adjusted between the open position and the closing position of the main valve, in each case by a simple manual pressure or tactile movement. With the aid of this push-push mechanism, which is known per se, the valve tappet can be switched between a switching position corresponding to the open position and a switching position corresponding to the closing position. In order to be able to vary the fluid volume flowing through the main valve in the open position as required or to be able to mix the fluids flowing into the main valve from different fluid inlets, for example hot and cold water, continuously with one another there, the main valve and the pilot valve are provided in the interior of an inner housing, which inner housing is rotatably mounted in an outer housing about a rotational axis. Here, the outer housing and the inner housing have paired valve openings, of which a first pair of valve openings arranged coaxially to the rotational axis is designed as a valve outlet and at least one second pair of valve openings lying outwardly relative to the rotational axis is provided as a valve inlet. In this case, the valve openings of the at least one pair of valve openings provided as a valve inlet, which are assigned to one another and are provided on the one hand in the inner housing and on the other hand in the outer housing, can be brought into congruence in accordance with the rotational position between the outer housing and the inner housing in such a way that the clear opening cross-section, kept free, of the at least one valve inlet produced by the congruence of said at least one second pair of valve openings can be modified. Thus, the at least one valve opening provided in the inner housing on the one hand can be made congruent more or less continuously with the valve opening, associated with it and arranged in the outer housing, of the at least one second pair of valve openings forming at least one valve inlet on the other hand, in such a way that the free opening cross-section of these valve openings allows a larger or also a smaller fluid volume to pass to the main valve. Since the valve openings of the first pair of valve openings forming the valve outlet of the main valve are arranged coaxially to the rotational axis between the outer housing and the inner housing and thus in the rotational axis, the opening cross-section of the valve outlet kept free by these preferably circular valve openings can also remain unchanged. The sanitary valve according to the invention, which is designed as a closing and regulating or vario valve or as a closing and mixing valve, can be produced from a reduced number of simply designed components and is distinguished by a compact design.

The simple design and production of the sanitary fitting according to the invention is favored in that the outer housing according to the invention and the inner housing optionally have a pot-shaped housing lower part.

It is advantageous here if the housing lower part of the inner housing is rotatably mounted in the housing lower part of the outer housing.

According to the invention, it is provided that the valve openings of the outer housing are arranged on the pot bottom of the housing lower part. A preferred embodiment according to the invention provides that the valve openings of the inner housing are arranged on the pot bottom of the housing lower part. If the valve openings of the outer housing and/or of the inner housing are arranged on the pot bottom of the housing lower part, it is free to provide an actuating element in operative and/or control connection with the valve tappet at the end face region of the outer housing and/or of the inner housing facing away from the housing lower part(s).

In order to secure the sanitary valve according to the invention against leaks and leakage flows in the region of the valve openings forming the valve outlet, it is advantageous if at least one first ring seal is provided between the outer housing and the inner housing, which first ring seal is arranged in the ring zone between the first valve openings and the second valve openings. In this way, a tight separation between valve inlet and valve outlet is also achieved in the region of the outer and inner housings, respectively, which are rotatably adjacent to each other.

An effective sealing and separation of the valve outlet from the at least one valve inlet is further favored if the at least one first ring seal is designed as a sealing ring and in particular as an X-ring sealing ring. If the sealing ring is formed as an X-ring sealing ring, this sealing ring has a substantially X-shaped ring cross-section. Alternatively, the first ring seal can also be designed as a lip seal.

In order to seal the separation zone between the outer housing and its housing lower part on the one hand and the inner housing and its housing lower part on the other hand liquid-tightly towards the outside, it is advantageous if at least one second ring seal is provided between the outer housing and the inner housing, which is arranged in the ring and/or circumferential zone of the outer and inner housings lying outwardly relative to the valve openings.

A further embodiment according to the invention provides here that the first and/or the second ring seal have a circular outer contour, the center of which is arranged in the rotational axis. If the first ring seal and/or the second ring seal have a circular outer contour and the center of these ring seals is arranged in the rotational axis, undesirable shear forces on the ring seal, which could lead to leaks over time, are avoided during relative rotation of the outer housing and inner housing.

A preferred development according to the invention provides that the pot bottom of the housing lower part of the inner housing is connected on the inside, preferably in one piece, to a sleeve-shaped inlet connection, the free sleeve end region of which, which can be acted upon by the diaphragm in the closing position, forms the valve seat of the main valve.

To facilitate easy handling of the sanitary valve according to the invention, it is advantageous if the inner housing protrudes with a guide portion over the outer housing, in which guide portion of the inner housing a push button in control and/or operative connection with the valve tappet is displaceably guided.

The easy handling of the sanitary valve according to the invention is further facilitated if the guide portion of the inner housing is connected for conjoint rotation to its housing lower part and is designed as a rotatable actuating element for relative rotation of the outer and inner housings.

A preferred embodiment according to the invention provides that the valve seat of the main valve is arranged between the at least one valve inlet and the valve outlet and is closable with the diaphragm, wherein the diaphragm closes off a pressure chamber which is finable from the at least one valve inlet, so that the diaphragm closes the valve seat in the closing position when the pressure chamber is filled and releases the valve seat in an open position when the pressure chamber is relieved.

In order for the position of the diaphragm to be predetermined by the position of the valve tappet and for the main valve to be actuatable between its open position and its closing position by means of the pilot valve, it is advantageous if the valve tappet can be used to close a relief opening on the diaphragm that opens out into the at least one valve outlet.

Since the sanitary valve according to the invention does not require a cartridge unit consisting of two ceramic discs resting against each other, a preferred embodiment according to the invention, which can be produced with little effort, provides that at least the housing lower part of the outer housing and/or inner housing is/are made of plastic.

Advantageous exemplary embodiments of the sanitary valve according to the invention provide that this sanitary valve is designed as a control and closing valve or as a mixing and closing valve.

If the sanitary valve according to the invention is designed as a mixing and closing valve, it can be advantageous if the sanitary valve has two valve inlets which can be varied by relative rotation of the outer and inner housings in such a way that the clear opening cross-section of the at least one second pair of valve openings forming the one valve inlet increases as a result of a relative rotation of the outer housing and inner housing, while that of the at least one other second pair of valve openings forming another valve inlet simultaneously decreases, and vice versa.

In one embodiment of the invention, it may be provided that a housing upper part, in particular the housing upper part already described, and a housing lower part, in particular the housing lower part already described, of the outer housing are latched together. Thus, a simple assembly without additional connecting elements is achievable.

In one embodiment of the invention, it may alternatively or additionally be provided that a housing upper part, in particular the housing upper part already described, and a housing lower part, in particular the housing lower part already described, of the outer housing are braced relative to each other by an elastic deformable element. Thus, manufacturing tolerances, in particular in relation to internal parts, can be compensated. A combination with a latching connection is particularly favorable, as the latching connection can then be tensioned after it has latched into place.

The deformable element can, for example, be formed here in one piece with the housing upper part and/or the housing lower part, in particular integrally molded thereon. This makes it possible to reduce the number of individual parts. Alternatively or additionally, the deformable element can also be formed separately from the housing parts. Thus, an optimum choice of material and/or interchangeability can be achieved.

### BRIEF DESCRIPTION OF THE DRAWINGS

Further embodiments according to the invention can be found in the following figure description in conjunction with the claims as well as the drawing. The invention is described in greater detail below with reference to a preferred exemplary embodiment.

In the figures:

FIG. 1 shows a sanitary valve in a longitudinal section, designed here as a closing and regulating or vario valve with a main valve which has a movable diaphragm, and with a pilot valve with which the main valve can be actuated between the open position shown here and a closing position, wherein the position of the diaphragm can be specified by the position of a valve tappet which is connected to a push-push mechanism with which the valve tappet can be switched between a switching position corresponding to the open position and a switching position corresponding to the closing position,

FIG. 2 shows the sanitary valve from FIG. 1, also shown here in longitudinal section, in the closing position of its main valve,

FIG. 3 shows the sanitary valve from FIGS. 1 and 2 in a pulled-apart single-part perspective view looking at the rear bottom view of its components,

FIG. 4 shows the sanitary valve shown in FIGS. 1 to 3 also in a single-part perspective view, looking at the front or top of the components on the actuation side,

FIG. 5 shows the sanitary valve from FIGS. 1 to 4 in a perspective view looking at its rear side,

FIG. 6 shows the sanitary valve from FIGS. 1 to 5 in a perspective view looking at the actuation side front or top of the sanitary valve,

FIG. 7 shows the housing lower part of an inner housing accommodating the main valve and the pilot valve in its housing interior in a top view of the housing interior,

FIG. 8 shows the housing lower part of the inner housing from FIG. 7 in a perspective top view of the housing interior,

FIG. 9 shows the inner housing from FIGS. 7 and 8 in a bottom or rear view of the housing end face of the inner housing facing an outer housing and formed as a pot bottom,

FIG. 10 shows the housing lower part of the inner housing shown in FIGS. 7 to 9 in a perspective rear or bottom view,

FIG. 11 shows the housing lower part of an outer housing of the sanitary valve shown in FIGS. 1 to 6 in a top view of the housing interior,

FIG. 12 shows the housing lower part from FIG. 11 in a perspective top view with a view of the housing interior,

FIG. 13 shows the housing lower part of FIGS. 11 and 12 in a top view of the rear end face of the sanitary valve,

FIG. 14 shows a perspective view of the housing lower part shown in FIGS. 11 to 13, looking at the rear end face of the sanitary valve shown in FIGS. 1 to 6,

FIG. 15 shows the rear end face of the sanitary valve shown in FIGS. 1 to 6, wherein the valve openings, provided in the housing lower parts of the inner housing and the outer housing, of a second pair of valve openings forming the valve inlet free only a small opening cross-section, which at most permits a minor flow through the sanitary valve shown here,

FIG. 16 shows the sanitary valve shown in FIGS. 1 to 6 in a rear plan view, wherein the valve openings provided in the housing lower parts and forming the valve inlet keep free here an approximately average opening cross-section corresponding to an average flow through the sanitary valve,

FIG. 17 shows the sanitary valve from FIGS. 1 to 6, wherein the valve openings provided in the housing lower parts of the outer housing and inner housing and forming the housing inlet are practically completely congruent, so that a full flow through the sanitary valve shown here is possible as compared with FIGS. 15 and 16,

FIG. 18 shows a sanitary valve designed as a mixing and closing valve in a perspective view looking at the valve inlets and outlets provided on the rear end face of the sanitary valve,

FIG. 19 shows the sanitary valve from FIG. 18 in a perspective view looking at its front side,

FIG. 20 shows a side view of the sanitary valve from FIGS. 18 and 19,

FIG. 21 shows the sanitary valve from FIGS. 18 to 20 in a plan view of its rear side showing the valve inlets and outlets,

FIG. 22 shows the sanitary valve from FIGS. 18 to 21 in a pulled-apart single-part perspective view looking at the rear of its components,

FIG. 23 shows the sanitary valve from FIGS. 18 to 22 in a single-part perspective view looking at the front of its components,

FIG. 24 shows the sanitary valve from FIGS. 18 to 23 in a pulled-apart view of some of its individual components, looking at the rear of these components,

FIG. 25 shows the sanitary valve from FIGS. 18 to 24 in a perspective view of some of its individual components, looking at the front of these components,

FIG. 26 shows the sanitary valve from FIGS. 18 to 25 in a longitudinal section, wherein the sanitary valve is shown here in the open position,

FIG. 27 shows the sanitary valve from FIGS. 18 to 26, also in a longitudinal section here, in its closing position,

FIG. 28 shows an isometric view of the sanitary valve from FIGS. 18 to 27, wherein the sanitary valve is arranged here in its open position,

FIG. 29 shows the housing lower part of an inner housing of the sanitary valve shown in FIGS. 18 to 28 in a top view of the housing interior of the pot-shaped housing lower part,

FIG. 30 shows a perspective view of the housing lower part from FIG. 29, looking at the housing interior,

FIG. 31 shows the housing lower part from FIGS. 29 and 30 in a top view looking at the rear of this housing lower part,

FIG. 32 shows a perspective view of the housing lower part from FIGS. 29 to 31, looking at the rear of this housing lower part,

FIG. 33 shows a housing lower part of an outer housing of the sanitary valve shown in FIGS. 18 to 28 in a top view of the housing interior of this housing lower part,

FIG. 34 shows the housing lower part from FIG. 33 in a perspective view with a view of the housing interior of this housing lower part,

FIG. 35 shows a top rear view of the housing lower part from FIGS. 33 and 34,

FIG. 36 shows a perspective view of the housing lower part from FIGS. 33 to 35, looking at the rear end face of this housing lower part,

FIG. 37 shows the housing lower parts rotatably guided one inside the other according to FIGS. 29 to 32 and 33 to 36, respectively, of the outer housing and inner housing, wherein the outer second pairs of valve openings each forming a valve inlet are brought into congruence in such a way that one pair of valve openings keeps a comparatively small clear cross-section free, while the pair of valve openings forming the other valve inlet by contrast keeps a comparatively large clear flow cross-section free,

FIG. 38 shows the housing lower parts of the outer housing and inner housing guided rotatably one inside the other in a rotational position, in which rotational position of the housing lower parts the two pairs of valve openings each forming a valve inlet keep free an approximately comparably large clear flow cross-section, and

FIG. 39 shows the housing lower parts of the outer housing and inner housing guided rotatably one inside the other in a rotational position, wherein in the rotational position shown here—in comparison with the rotational position in FIG. 37—the one pair of valve openings forming a valve inlet now leaves a comparatively small clear flow cross-section, while by contrast the clear flow cross-section kept free by the other pair of valve openings forming a further valve inlet is now substantially larger.

### DETAILED DESCRIPTION

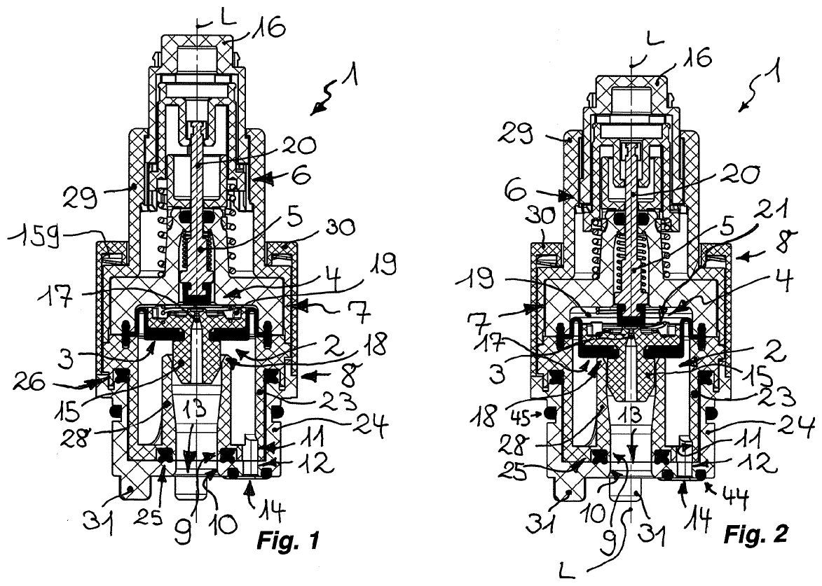

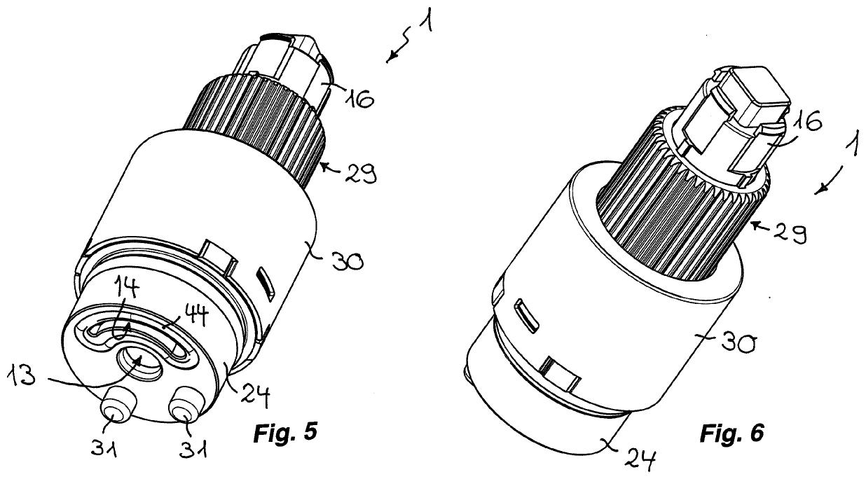

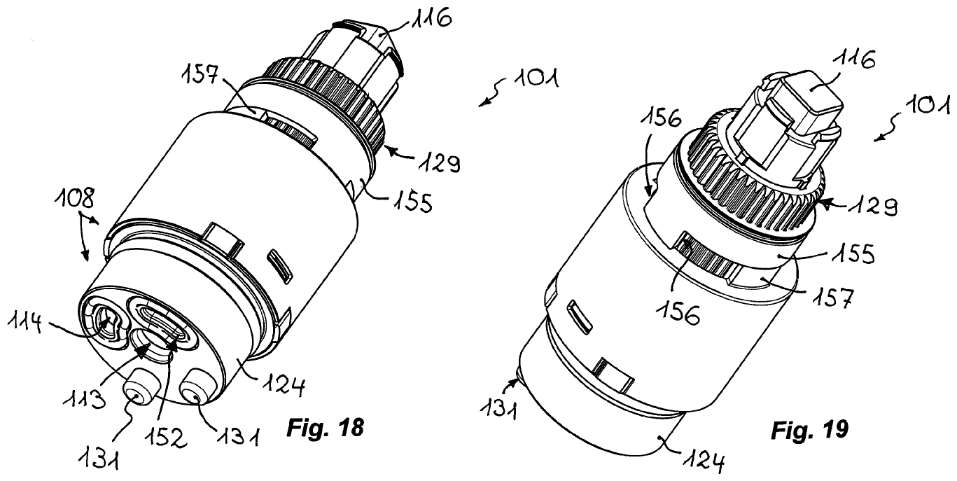

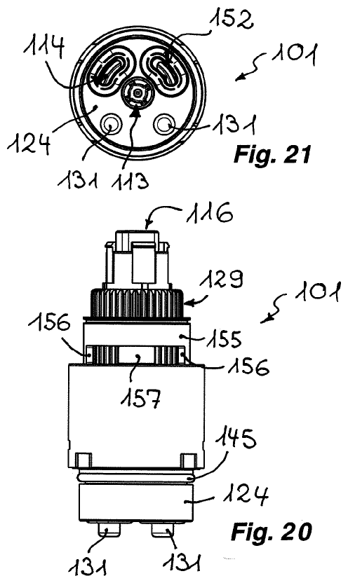

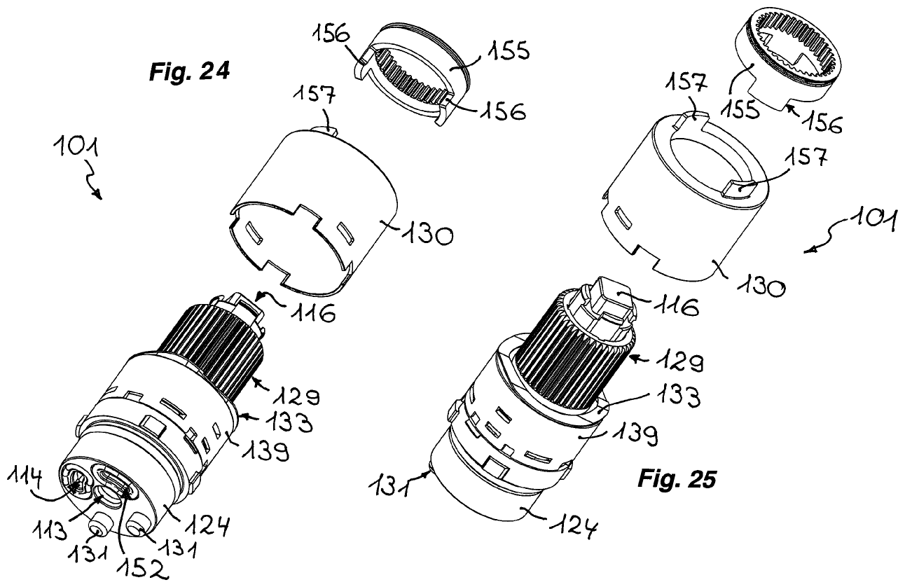

FIGS. 1 to 6 and 18 to 28 show two embodiments 1, 101 of a sanitary valve which serves to open and close a water line and which can, for example, be installed in the body of a sanitary outlet fitting. While the sanitary valve 1 shown in FIGS. 1 to 6 serves as a control and closing valve, the sanitary valve 101 shown in FIGS. 18 to 28, on the other hand, is designed as a mixing and closing valve. The sanitary valves 1, 101 shown here have a main valve 2, 102 which has a movable diaphragm 3, 103 as a valve body. The sanitary valve 1, 101 also has a pilot valve 4, 104 with which the main valve 2, 102 can be actuated between an open position and a closing position. Here, the position of the diaphragm 3, 103 can be specified by the position of a valve tappet 5, 105, which is connected to a push-push mechanism 6, 106. This push-push mechanism 6, 106 can be designed as a rotary/latching or also as a ballpoint pen mechanism and permits here an adjustment of the valve tappet 5, 105 at least between the open position and the closing position of the main valve 2, 102 in each case by a simple manual pressure or tactile movement. By means of this push-push mechanism 6, 106, the valve tappet 5, 105 can be switched between the switching position of the main valve 2, 102 corresponding to the open position and shown in FIGS. 1, 26 and 18 and a switching position corresponding to the closing position and shown in FIGS. 2 and 27.

In order to be able to vary the amount of fluid flowing through the main valve 2, 102 in the open position as required and to adjust it manually, or in order to be able to mix the liquids flowing in via two liquid inlets not shown here, for example hot and cold water, in the main valve 102 and to vary their proportions, the main valve 2, 102 and the pilot valve 4, 104 are provided in the housing interior of an inner housing 7, 107, which inner housing 7, 107 is mounted in an outer housing 8, 108 so as to be rotatable about a rotational axis L. The outer housing 8, 108 and the inner housing 7, 107 have valve openings 9, 10; 11, 12 and 109, 110; 111, 112 and 150, 151 which are assigned to each other in pairs, of which a first pair of valve openings 9, 10; 109, 110, which is arranged coaxially with respect to the rotational axis, is designed as a valve outlet 13, 113, and of which at least one second pair of valve openings 11, 12; 111, 112 and 150, 151, lying outwardly relative to the rotational axis L, is provided as at least one valve inlet 14; 114, 152. In this case, the second pair of valve openings 11, 12 or 111, 112 and 150, 151 can be brought into or out of congruence between the outer and inner housings 8, 7; 108, 107 in accordance with the rotational position in such a way that the clear opening cross-section of the valve inlet 14; 114, 152 which is kept free by the congruence of this second pair of valve openings 11, 12; 111, 112 and 150, 151 can be modified. Thus, the valve opening 11, 111, 150 provided in the inner housing 7, 107 can be made to coincide more or less continuously with the assigned valve opening 12, 112, 151, arranged in the outer housing 8, 108, of the at least one second pair of valve openings 11, 12; 111, 112, 150, 151 forming the valve inlet 14, 114 and 152, in such a way that the opening cross-section of these valve openings 11, 12; 111, 112 and 150, 151 that is kept free allows a larger or also a smaller volume of fluid to pass to the main valve 2, 102.

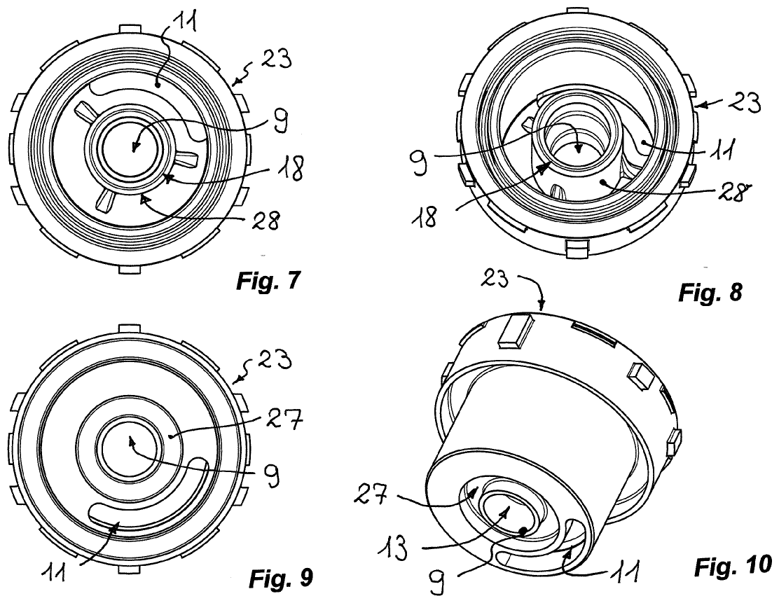

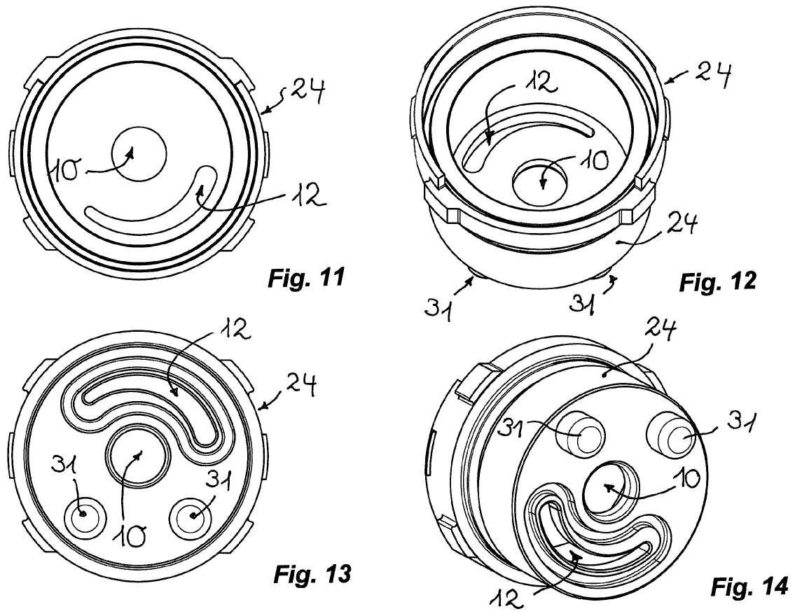

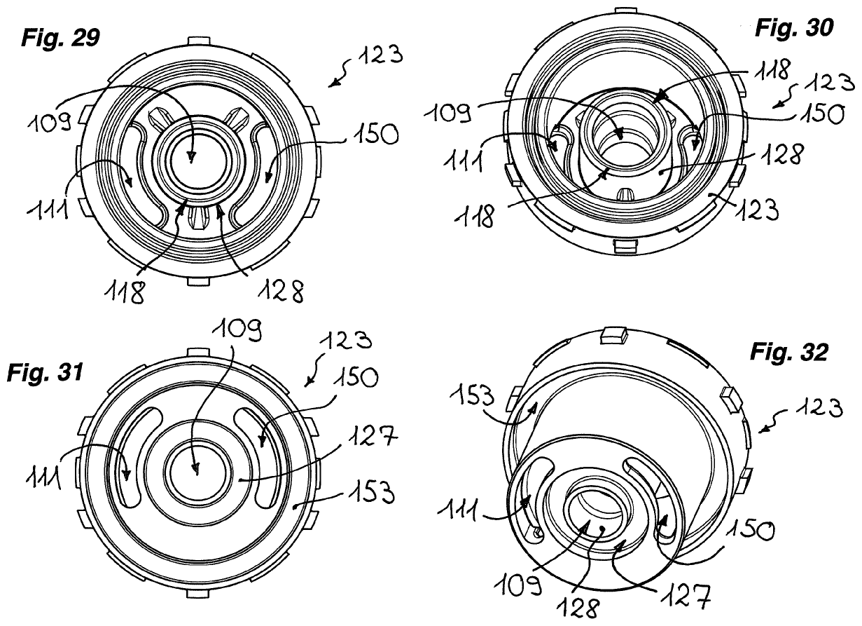

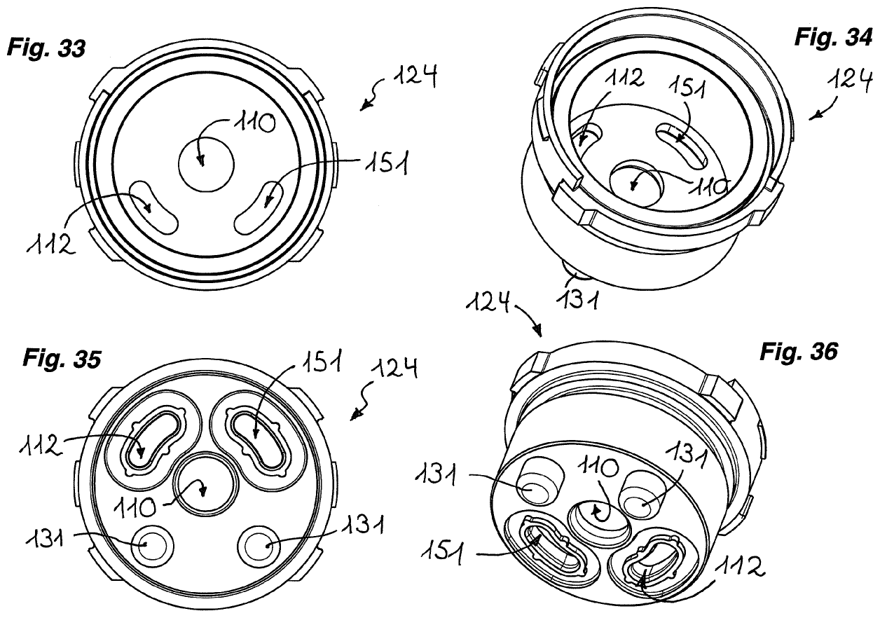

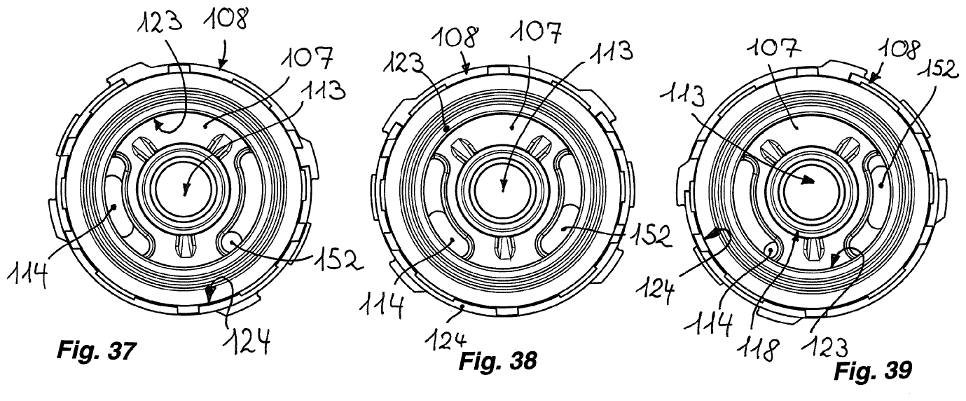

Since the valve openings 9, 10; 109, 110 forming the first pair, which pair serves as the valve outlet 13, 113 of the main valve 2, 102, are arranged coaxially to the rotational axis L between the outer housing 8, 108 and the inner housing 7, 107 and thus in the rotational axis L, the opening cross-section kept free by these, here, circular valve openings 9, 10; 109, 110 can also remain unchanged. The sanitary valves 1, 101 according to FIGS. 1 to 17 and 18 to 39 can be produced from a reduced number of components of simple design and are characterized by a compact design.

As can be seen in particular from FIGS. 1 and 2 and 26 to 28, respectively, the main valve 2, 102 of the sanitary valves 1, 101 is equipped with the movable diaphragm 3, 103, which is made of an elastic material and supports a valve body 15, 115 of the main valve 2, 102. The diaphragm 3, 103 is actuatable by the pilot valve 4, 104. For this purpose, the pilot valve 4, 104 has the longitudinally displaceable valve tappet 5, 105, the position of which along its travel specifies the respective position of the valve body 15, 115 and thus of the diaphragm 3, 103.

The sanitary valve 1, 101 further comprises the push-push mechanism 6, 106. A push button 16, 116 is formed on the outside of this push-push mechanism 6, 106, by means of which the push-push mechanism 6, 106 can be switched between different switching positions, and in particular between the open position and the closing position of the main valve 2, 102, by repeated pressing. The push-push mechanism 6, 106 is in operative or control connection with the valve tappet 5, 105. The push-push mechanism 6, 106 has at least two switch states corresponding to the open position and the closing position, between which the valve tappet 5, 105 can be switched on the basis of the operative connection.

In FIGS. 2 and 27, a lower or outer switching position is shown, in which the main valve 2, 102 is closed and thus is in its closing position. FIGS. 1, and 26 and 28, respectively, show an upper or further outer switching position in which the main valve 2, 102 is fully open and thus is in its open position.

The pilot valve 4, 104 has a relief opening 17, 117 formed on the valve body 15, 115 and thus on the movable diaphragm 3, 103. If this relief opening 17, 117 is closed, a pressure builds up which presses the diaphragm 3, 103 with the valve body 15, 115 into a valve seat 18, 118 of the main valve 2, 102. The main valve 2, 102 is then in its closing position.

When the relief opening 17, 117 is opened, the aforementioned pressure is reduced so that the diaphragm 3, 103 with the valve body 15, 115 moves away from the valve seat 18, 118. The main valve 2, 102 is thus opened.

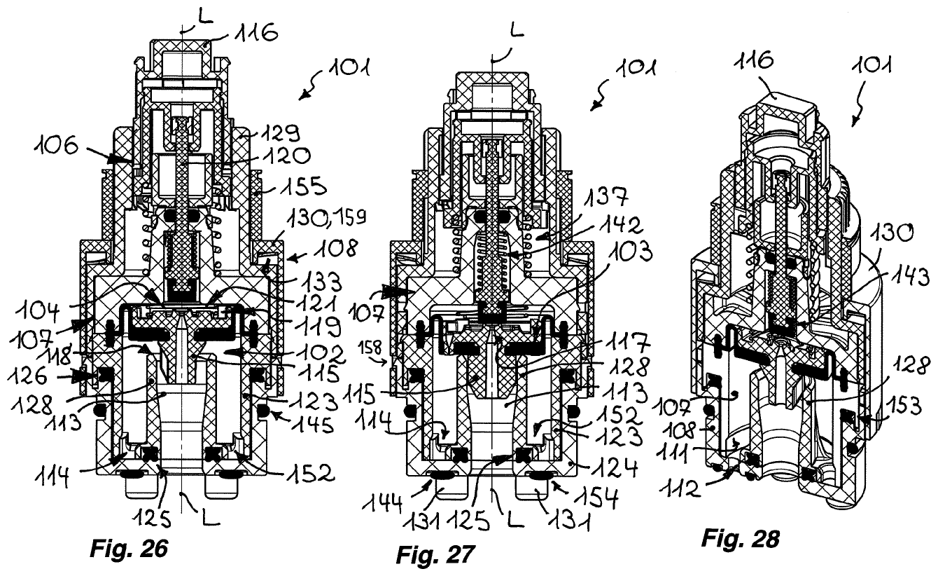

Accordingly, FIGS. 1 and 2 as well as FIGS. 26 and 28 on the one hand and FIG. 27 on the other hand show different positions of the valve tappet 5, 105 of the sanitary valves 1, 101, each of which forms a switching position of the at least two switching positions of the main valve 2, 102, as can be specified by the push-push mechanism 6, 106.

While FIGS. 1, and 26 and 28, respectively, show an outer switching position defining an open position of the pilot valve 4, 104; FIGS. 2 and 27 show a further outer switching position defining a closing position of the pilot valve 4, 104.

The main valve 2, 102 has the valve seat 18, 118, which can be tightly closed with the valve body 15, 115 and the diaphragm 3, 103. The valve seat 18, 118 is arranged in the direction of flow between the valve inlet 14 or the valve inlets 114, 152 and the valve outlet 13, 113. The main valve 2, 102 therefore serves to separate the valve inlets 14; 114, 152 as well as the valve outlet 13, 113 of the main valve 2, 102 provided in the sanitary valves 1, 101.

The diaphragm 3, 103 closes off a pressure chamber 19, 119 which can be filled from the valve inlet 14 or the valve inlets 114, 152 via a filling opening in the diaphragm 3, 103 or its valve body 15, 115, which is not readily visible here. This filling opening is always open. This ensures that the diaphragm 3, 103 with the valve body 15, 115 arranged thereon closes the valve seat 18, 118 when the pressure chamber 19, 119 is filled in the closing position of the sanitary valves 1, 101 shown in FIGS. 2 and 27 and frees the valve seat 18, 118 when the pressure chamber 19, 119 is relieved in the open position of the sanitary valves 1, 101 shown in FIGS. 1 and 26 and 28, respectively.

As already mentioned above, the relief opening 17, 117 can be closed and released by the valve tappet 5, 105. Since the relief opening 17, 117 opens out into the valve outlet 13, 113, opening the relief opening 17, 117 leads to the aforementioned pressure reduction in the pressure chamber 19, 119 and thus to opening of the main valve 2, 102 of the sanitary valves 1, 101. For this purpose, the relief opening 17, 117 is dimensioned larger than the filling opening mentioned above.

The valve tappet 5, 105 provided in the sanitary valves 1, 101 is coupled to the push-push mechanism 6, 106 via a control element 20, 120 to assume the switching positions already described. The control element 20, 120 is inserted tightly into the pressure chamber 19, 119 from the outside. Also formed in the operative connection between the pilot valve 4, 104 and the push-push mechanism 6, 106 is a compensating device that permits actuation of the push-push mechanism 6, 106 even when the pilot valve 4, 104 is closed and cannot be moved further against the valve seat 18, 118.

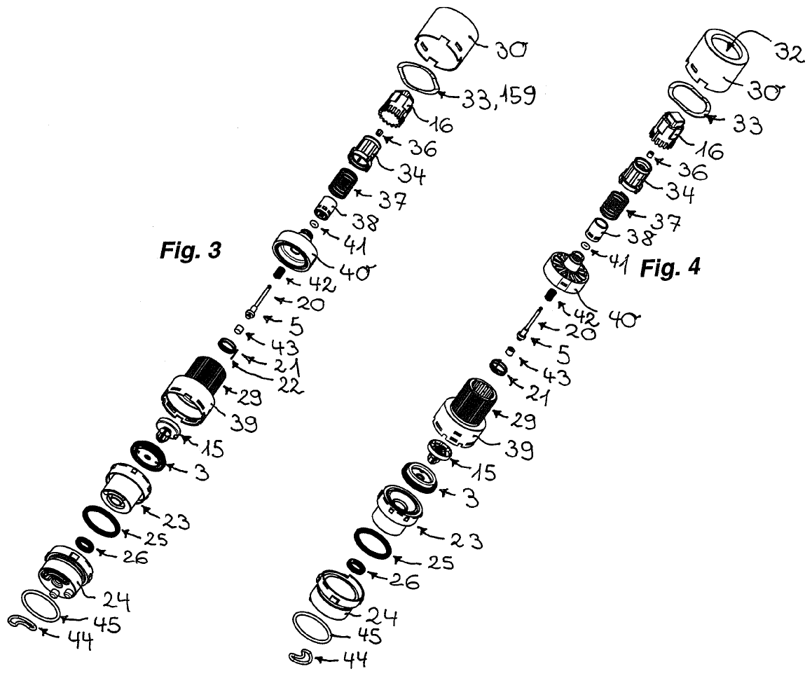

In the single-part illustrations according to FIGS. 3 and 4 and FIGS. 22 and 23, respectively, it can be seen that the main valve 2, 102 of the sanitary valves 1, 101 also has a cleaning element 21, 121, which is designed to be resiliently flexible and, with a pin-shaped free end 22, 122, passes through and keeps free the filling opening in the diaphragm 3, 103 or its valve body 15, 115, which cannot be seen further here. With its other end, the cleaning element 21, 121 is fixedly arranged in the inner housing 7, 107.

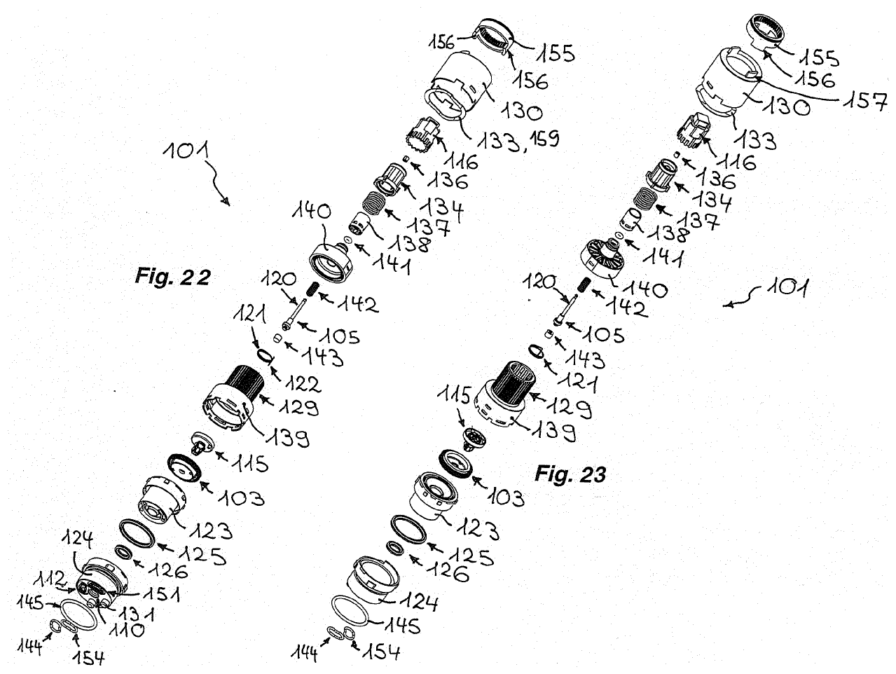

From a comparison of FIGS. 1 and 2 and FIGS. 7 to 14 on the one hand and FIGS. 22, 23 and 26 to 36 on the other, it can be seen that the inner housing 7, 107 and the outer housing 8, 108 each have a pot-shaped housing lower part 23, 24; 123, 124. Here, the housing lower part 23, 123 of the inner housing 7, 107 is rotatably mounted in the housing lower part 24, 124 of the outer housing 8, 108. The valve openings 9, 10; 11, 12 and 109, 110; 111, 112 and 150, 151, respectively, of the inner housing 7, 107 and of the outer housing 8, 108 are each arranged on the pot bottom of the housing lower parts 23, 24; 123, 124. A first ring seal 25, 125 is provided between the outer housing 8, 108 and the inner housing 7, 107 and is arranged in the ring zone between the first valve openings 9, 10; 109, 110 and the second valve openings 11, 12; 111, 112 and 150, 151. This first ring seal 25, 125 is designed here as a sealing ring and in particular as an X-ring sealing ring.

In FIGS. 1 and 2 and 26 to 28, respectively, it can be seen that at least one second ring seal 26, 126 is provided between the outer housing 8, 108 and the inner housing 7, 107, which is arranged in the ring and/or circumferential zone of the inner and outer housings 7, 8; 107, 108, lying outwardly relative to the valve openings 9, 10; 11, 12 and 109, 110; 111, 112 and 150, 151, respectively. Since the ring seals 25, 26; 125, 126 have a circular outer contour, the center of which is arranged in the rotational axis L, no undesirable shear forces act on the ring seals 25, 26; 125, 126 during relative rotation of the inner housing 7, 107 and outer housing 8, 108, which could possibly lead to increased wear and/or leaks.

In FIGS. 1 and 2 and also 26 to 28, it can be seen that the first ring seal 25, 125 and also the second ring seal 26, 126 are each arranged in a groove 27, 153 in the housing lower part 23, 123 of the inner housing 7, 107.

From a comparison of FIGS. 1, 2 and 7 to 10 and FIGS. 26 to 28 and 29 to 30, respectively, it is clear that the pot bottom of the housing lower part 23, 123 of the inner housing 7, 107 is connected in one piece on the inner side to a sleeve-shaped valve connection 28, 128, the free sleeve end region of which forms the valve seat 18, 118.

As can also be seen in FIGS. 1 and 2 and FIGS. 26 to 28, the inner housing 7, 107 projects with a guide portion 29, 129 over the outer housing 8, 108. The push button 16, 116, which is in control or operative connection with the valve tappet 5, 105, is displaceably guided in this guide portion 29, 129 of the inner housing 7, 107. The guide portion 29, 129 of the inner housing 7, 107 is connected to its housing lower part 23, 123 and is designed here as a rotatable actuating element for relative rotation of the outer housing 8, 108 and inner housing 7, 107. In this case, the outer housing 8, 108 encloses the inner housing 7, 107 with the exception of the valve inlet 14, 114, 152, valve outlet 13, 113, 151 and guide portion 29, 129 in a partial region designed here as a cylindrical cross-sectional extension, which partial region is delimited at its end faces on both sides with respect to the adjacent portions of the inner housing 7, 107 by ring shoulders. The housing lower part 24, 124 is preferably detachably connected to a housing upper part 30, 130 which is also pot-shaped here. On the rear end face of the housing lower part 24, 124, at least one anti-rotation projection 31, 131, arranged eccentrically here, protrudes and, when installed in the body of a sanitary fitting, not shown further here, can serve as an anti-rotation device, attached to the outer housing 8, 108, of the sanitary valve 1, 101 with its inner housing 7, 107 rotatable in the housing interior of the outer housing 8, 108.

In the individual perspective views shown in FIGS. 3 and 4 and FIGS. 22 and 23, the pot-shaped housing upper part 30, 130 of the outer housing 8, 108 can be seen, which has a central through-opening 32, 132 for the guide portion 29, 129 of the inner housing 7, 107 in the region of its pot bottom. In the region of this passage opening 32, 132, a corrugated pressure spring washer 33, 133 is inserted into the outer housing 8, 108 and presses the inner housing 7, 107 with its housing lower part 23, 123 into the housing lower part 24, 124 of the outer housing 8, 108 and against the second ring seal 26, 126.

This pressure spring washer 33, 133 can accommodate manufacturing tolerances of the components and tension a detent connection 158 (cf. FIG. 27) between the housing upper part 30 and the housing lower part 24 of the outer housing 8.

Instead of the pressure spring washer 33, 133, another elastically deformable element 159 may be inserted, and/or elastically deformable elements may be formed in one piece on the housing lower part 24 and/or the upper housing part 30.

Below the pressure spring washer 33, 133, the push button 16, 116 can be seen, onto which, if necessary, a cap, not further shown here, can also be detachably latched or the like. A rotary cap 34, 134 of the push-push mechanism 6, 106 can be inserted into the sleeve-shaped push button 16, 116, into which rotary cap 34, 134 the control element 20, 120 of the valve tappet 5, 105 projects. A groove 35, 135 is provided on the circumference of the rod-shaped control element 20, 120, into which a clip 36, 136 can be inserted, which connects the valve tappet 5, 105 and its control element 20, 120 captively but displaceably to the rotary cap 34, 134. A resetting element 37, 137 designed as a compression spring acts on the rotary cap 34, 134 and a bushing 38, 138 inserted therein. The housing upper part of the inner housing 7, 107 is formed in two parts here and has an outer part 39, 139 carrying the guide portion 29, 129, into which an inner part 40, 140 is inserted. The control element 20, 120 of the valve tappet 5, 105 is guided in a central guide opening in the inner part 40, 140, wherein the control element 20, 120 is sealed in the guide opening by a sealing ring 41, 141. In the inner part 40, 140, the valve tappet 5, 105 is pressed in the direction of the diaphragm 3, 103 by means of a helical compression spring 42, 142. In order that the valve tappet 5, 105 can tightly close the relief opening 17, 117 in the diaphragm 3, 103, it has a sealing cap 43, 143 at its tappet end facing the diaphragm 3, 103. Inside the housing lower part 23, 123, the cleaning element 21, 121 formed as a compression spring is shown with its end 22, 122 projecting into the vent opening in the diaphragm 3, 103. The outer part 39, 139 of the inner housing 7, 107 has the guide portion 29, 129, which has a profiling formed by longitudinal grooves on its cylindrical outer circumference, onto which profiled guide portion 29, 129 a sleeve-shaped cap, not shown further here, can be fitted if required. Within the outer part 39, 139, the valve body 15, 115 can be seen, which is connected to the diaphragm 3, 103 in a latched manner or the like at a central fastening opening of the diaphragm.

As can be seen from FIGS. 1 to 4 and 22 to 23 and 26 to 28, respectively, the first and second ring seal 25, 26 are each formed here as an X-ring seal.

In further exemplary embodiments, the ring seal 25 and/or the ring seal 26 is/are designed as a lip seal.

In FIGS. 3 and 22 to 23, it can be seen that the second pairs of valve openings 11, 12, 111, 112 and 150, 151 serving as valve inlet 14 and valve inlets 114, 152, respectively, each have an opening outline which is bent in the circumferential direction and is formed as a slot. Here, a correspondingly curved ring seal 44, 144, 154 is held on the outside of the housing lower part 24, 124 of the outer housing 8, 108, respectively, which circulates around the valve opening 12, 112, 151 on the outside. In order to be able to insert the sanitary valve 1, 101 tightly into the body of an outlet fitting, not shown further here, a ring seal 45, 145 is provided on the outer circumference of the housing lower part 24, 124 of the outer housing 8, 108.

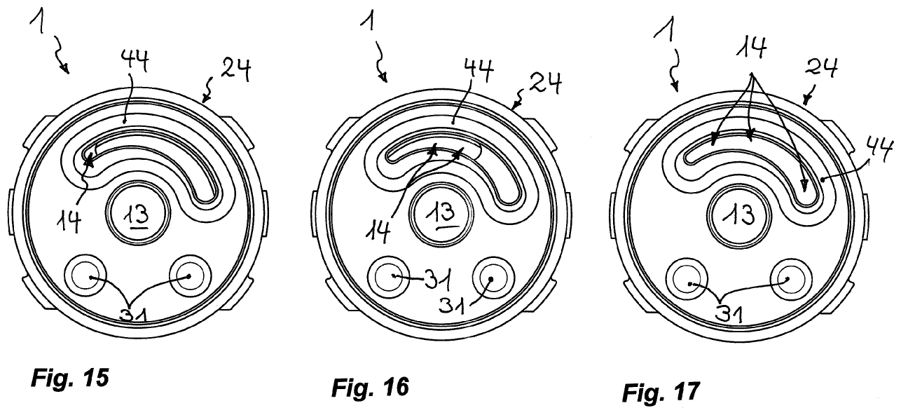

From a comparison of FIGS. 15 to 17 and 37 to 39, it is clear that the second pairs of valve openings 11, 12; 111, 112 and 150, 151 provided in the housing lower parts 23, 24; 123, 124 can be brought into congruence between the outer housing 8, 108 and the inner housing 7, 107 rotatably guided therein in accordance with the rotational position in such a way that the clear opening cross-section of the valve inlet 14; 114, 152 formed by the congruence of these second pairs of valve openings 11, 12; 111, 112 can be modified.

The sanitary valve 1 according to FIGS. 1 to 17 forms a closing and regulating or vario valve, the main valve 2 of which can be opened and closed in each case by pressure movements on the push button 16, while the flow rate flowing out of the sanitary valve 1 in the open position of the main valve 2 can be adjusted by turning the profiled guide portion 29 serving as an actuating element.

By contrast, the sanitary valve 101 according to FIGS. 18 to 39 is designed as a closing and mixing valve, the main valve 102 of which can also be opened and closed by pressure movements at the push button 116 and in which the clear opening cross-section at the valve inlets 114, 152 can be adjusted in such a way that the clear opening cross-section at one valve inlet 114; 152 is increased by a rotary movement, while at the same time the clear opening cross-section kept free at the other valve inlet 152; 114 decreases, and vice versa. The valve inlets 114, 152 open out into a common mixing chamber formed in the housing lower part 123 between the valve connection 128 and the housing inner circumference of the housing lower part 123. The fluid portions of, for example, hot water and cold water flowing in through the valve inlets 114, 152 are mixed together in the mixing chamber of the housing lower portion 123 and can flow out from there as mixed water via the valve outlet 113 of the main valve 102. In order to limit the relative rotational movement between the inner housing 107 and the outer housing 108 in both directions of rotation, a rotational stop ring 155 is mountable on the profiled guide portion 129 and has rotational stops 156 that cooperate with counter stops 157 on the upper housing part 130 of the outer housing 108.

In the exemplary embodiments shown, an open design is formed in each case, wherein the valve outlet 13, 113 is designed without a directly assigned seal in each case. Sealing to the outside is achieved by a sealing ring that is inserted into an external groove on the housing lower part 24, 124.

In further exemplary embodiments, a closed design is formed in which the valve outlet 13, 113 is provided with a sealing ring that passes between the valve outlet 13, 113 and the valve inlet 14. The seal on the outside of the housing lower part 24, 124 can then be omitted.

Since the sanitary valves 1, 101 shown here are distinguished by a very small tolerance chain of their dependent components and parts, the sanitary valves 1, 101 shown here have a high repeatability in volume or mixing variation.

### LIST OF REFERENCE SIGNS

1 sanitary valve (according to FIGS. 1 to 17)
2 main valve
3 diaphragm
4 pilot valve
5 valve tappet
6 push-push mechanism
7 inner housing
8 outer housing
9 valve opening (in the inner housing 7)
10 valve opening (in the outer housing 8)
11 valve opening (in the inner housing 7)
12 valve opening (in the outer housing 8)
13 valve outlet
14 valve inlet
15 valve body
16 push button
17 relief opening
18 valve seat
19 pressure chamber
20 control element
21 cleaning element
22 free end of the cleaning element 21
23 housing lower part of the inner housing 7
24 housing lower part of the outer housing 8
25 first ring seal
26 second ring seal
27 groove
28 valve connection
29 guide portion
30 housing upper part of the outer housing 8
31 anti-rotation projections on the outer housing 8
32 passage opening
33 corrugated spring washer
34 rotary cap
35 groove
36 clip
37 resetting element
38 bushing
39 outer part
40 inner part
41 sealing ring
42 helical compression spring
43 sealing cap
44 ring seal
45 ring seal
101 sanitary valve (according to FIGS. 18 to 39)
102 main valve
103 diaphragm
104 pilot valve
105 valve tappet
106 push-push mechanism
107 inner housing
108 outer housing
109 valve opening (in the inner housing 107)
110 valve opening (in the outer housing 108)
111 valve opening (in the inner housing 107)
112 valve opening (in the outer housing 108)
113 valve outlet
114 (first) valve inlet
115 valve body
116 push button
117 discharge opening
118 valve seat
119 pressure chamber
120 control element
121 cleaning element
122 free end of the cleaning element 121
123 housing lower part of the inner housing 107
124 housing lower part of the outer housing 108
125 first ring seal
126 second ring seal
127 groove
128 valve connection
129 guide portion
130 housing upper part of the outer housing 108
131 anti-rotation projections on the outer housing 108
132 passage opening
133 corrugated spring washer
134 rotary cap
135 groove
136 clip
137 resetting element
138 bushing
139 outer part
140 inner part
141 sealing ring
142 helical compression spring
143 sealing cap
144 ring seal
145 ring seal
150 valve opening (in the inner housing 107)
151 valve opening (in the outer housing 108)
152 (second) valve inlet
153 groove
154 ring seal
155 rotational stop ring
156 rotational stops (on the rotational stop ring 155)
157 counter stops
158 latching connection
159 elastically deformable element
L rotational axis

1. A sanitary valve (1, 101) comprising,
a main valve (2, 102) which has a movable diaphragm (3, 103);
a pilot valve (4, 104), by which the main valve (2, 102) is actuatable between an open position and a closing position;
a valve tappet (5, 105) by which a position of the diaphragm (3, 103) is specifiable;
the valve tappet (5, 105) is connected to a push-push mechanism (6, 106), by which (6, 106) the valve tappet (5, 105) is switchable between a switching position corresponding to the open position and a switching position corresponding to the closing position;
an inner housing (7, 107) in an interior of which the main valve (2, 102) and the pilot valve (4, 104) are located;
an outer housing (8, 108) in which the inner housing (7, 107) is rotatably mounted or movement about a rotational axis (L);
the outer housing (8, 108) and the inner housing (7, 107) have paired valve openings (9, 10; 11, 12; 109, 110; 111, 112; 150, 151), of which a first pair of the valve openings (9, 10; 109, 110) arranged coaxially to the rotational axis (L) provide a valve outlet (13, 113) and at least one second pair of valve openings (11, 12; 111, 112; 150, 151) lying outwardly relative to the rotational axis (L) provide at least one valve inlet (14; 114, 152);
the at least one second pair of valve openings (11, 12; 111, 112; 150, 151) is movable into congruence according to a rotational position between the outer and inner housings (8, 7; 108, 107), wherein a clear opening cross section of the at least one valve inlet (14; 114, 152) which is kept free by the congruence of said second valve openings (11, 12; 111, 112; 150, 152) is modifiable;
the outer housing (8, 108) has a pot-shaped housing lower part (24; 124); and the valve openings (10, 12; 110, 112, 151) of the outer housing (8, 108) are arranged on the pot bottom of the housing lower part (24; 124).

2. The sanitary valve as claimed in claim 1, wherein the inner housing (7, 107) has a pot-shaped housing lower part (23; 123).

3. The sanitary valve as claimed in claim 2, wherein the housing lower part (23, 123) of the inner housing (7, 107) is rotatably mounted in the housing lower part (24, 124) of the outer housing (8, 108).

4. The sanitary valve as claimed in claim 3, wherein the valve openings (9, 11; 109, 111, 150) of the inner housing (7, 107) are arranged on the pot bottom of the housing lower part (23; 123).

5. The sanitary valve as claimed in claim 1, further comprising at least one first ring seal (25, 125) between the outer housing (8, 108) and the inner housing (7, 107), said first ring seal (25, 125) is arranged in a ring zone between the first pair of valve openings (9, 10; 109, 110) and the at least one second pair of valve openings (11, 12; 111, 112, 150, 151).

6. The sanitary valve as claimed in claim 5, further comprising at least one second ring seal (26, 126) between the outer housing (8, 108) and the inner housing (7, 107) and is arranged in at least one of the ring or a circumferential zone of the outer and inner housing (8, 7; 108, 107) lying outwardly relative to the valve openings (9, 10, 11, 12; 109, 110, 111, 112, 150, 151).

7. The sanitary valve as claimed in claim 6, wherein at least one of the at least one first ring seal (25, 125) or the at least one second ring seal (26, 126) comprises a sealing ring.

8. The sanitary valve as claimed in claim 6, wherein at least one of the first or the second ring seal (25, 26; 125, 126) have a circular outer contour, a center of which is located on the rotational axis (L).

9. The sanitary valve as claimed in claim 6, wherein at least one of the first or the second ring seal (25, 26; 125, 126) is arranged in a groove (27, 127, 153) in the housing lower part (24, 124) of the outer housing (8, 108).

10. The sanitary valve as claimed in claim 6, wherein at least one of the first or the second ring seal (25, 26; 125, 126) is arranged in a groove (27, 127, 153) in the housing lower part (23, 123) of the inner housing (7, 107).

11. The sanitary valve as claimed in claim 6, wherein a pot bottom of a housing lower part (23, 123) of the inner housing (7, 107) is connected to a sleeve-shaped valve connection (28, 128), a free sleeve end region of which forms the valve seat (18, 118).

12. The sanitary valve as claimed in claim 1, wherein the inner housing (7, 107) projects with a guide portion (29, 129) over the outer housing (8, 108), and a push button (16, 116) in at least one of control or operative connection with the valve tappet (5, 105) is displaceably guided in the guide portion (29, 129) of the inner housing (7, 107).

13. The sanitary valve as claimed in claim 12, wherein the guide portion (29, 129) of the inner housing (7, 107) is connected to with a housing lower part (23, 123) for conjoint rotation and is designed as a rotatable actuating element for relative rotation of the inner housing (7, 107) and the outer housing (8, 108).

14. The sanitary valve as claimed in claim 11, wherein the valve seat (18, 118) is arranged between the at least one valve inlet (14, 114, 152) and the valve outlet (13, 113), and said valve seat (18, 118) is closeable with the diaphragm (3, 103), wherein the diaphragm (3, 103) closes a pressure chamber (19, 119) which is fillable from the at least one valve inlet (14, 114, 152), so that the diaphragm (3, 103) closes the valve seat (18, 118) in a closing position when the pressure chamber (19, 119) is filled and releases the valve seat (18, 118) in an open position when the pressure chamber (19, 119) is relieved.

15. The sanitary valve as claimed in claim 14, wherein a relief opening (17, 117) on the diaphragm (3, 103) opening out into the at least one valve outlet (13, 113) is closeable with the valve tappet (5, 105).

16. The sanitary valve as claimed in claim 1, wherein at least the housing lower part (24; 124) of the outer housing (8, 108), or the housing lower part (23, 123) of the inner housing (7, 107), or both are made of plastic.

17. The sanitary valve as claimed in claim 1, wherein the sanitary valve comprises a regulating and closing valve (1) or a mixing and closing valve (101).

18. The sanitary valve as claimed in claim 1, wherein the at least one valve inlet comprises two of the valve inlets (114, 152), of which the pairs of valve openings (111, 112, 150, 152) forming the valve inlets (114, 152) are movable into congruence such that, by a rotary movement of the inner housing (107) and the outer housing (108), the clear opening cross-section at one of the valve inlets (114, 152) is increased, while the clear opening cross-section at the other valve inlet (152, 114) decreases, and vice versa.

19. The sanitary valve as claimed in claim 1, wherein a housing upper part (30) and the housing lower part (24) of the outer housing (8, 108) are at least one of latched together or braced relative each other by an elastic deformable element (159).
